(19) United States
(12) Patent Application Publication
(10) Pub. No.: US 2017/0246746 A1
(43) Pub. Date: Aug. 31, 2017

(54) ASSEMBLY OF A ROBOT OF HUMANOID NATURE

(71) Applicant: SOFTBANK ROBOTICS EUROPE, PARIS (FR)

(72) Inventor: Nikolaos PATEROMICHELAKIS, PARIS (FR)

(21) Appl. No.: 15/329,973

(22) PCT Filed: Jul. 28, 2015
(86) PCT No.: PCT/EP2015/067267

§ 371 Date: Jan. 27, 2017

(30) Foreign Application Priority Data
Jul. 30, 2014 (FR) 1457367

(51) Int. Cl. B25J 19/00; H02G 11/02; B25J 17/02

(52) U.S. Cl. CPC B25J 19/007; B25J 19/0029; B25J 17/0241; H02G 11/02

(57) ABSTRACT

A method for assembling a humanoid type robot comprises two elements and an articulation with freedom in rotation linking the two elements about an axis, the articulation mounted and dismantled to join and separate the two elements. The robot comprises: a box with circular section fixed to a first element and extending along an axis parallel to the axis of rotation of the articulation, a cable having two ends, a first is connected to the first element and a second is connected to the second element. The cable is partly wound in the box about the axis of the box and extends out of the box to its second end. Between a separated and joined configuration of the two elements, an elasticity of the cable allows it to be wound in the box. The robot is assembled by connecting the cable at its two ends then mechanically mounting the articulation.

The invention relates to improving the assembly of a robot of humanoid type.

A robot can be qualified as humanoid from the moment when it has certain attributes of the appearance and of the functionalities of a human such as, for example, a head, a trunk, two arms, two hands, two legs or two feet. Some robots having only the top part of the body can also be considered to be of humanoid type. There are humanoid robots capable of walking or of moving around on a platform provided with wheels, of making gestures, with the limbs or with the head. The complexity of the gestures that they are capable of performing is constantly increasing.

To achieve this, the robots comprise many mutually articulated elements. Mechanically, the articulations comprise numerous degrees of freedom; furthermore, it is necessary to convey signals and power between the different articulated elements. In other words, when a robot is assembled, it is necessary to mechanically link the different elements of the robot and to connect them so as to convey the signals and the power necessary to the operation of the robot. The signals and the power can take different forms, for example electrical, optical or hydraulic.

As is known, when assembling a robot, the mechanical assembly is first of all established before the other connections. This order makes it possible to limit the lengths of the cables to be connected. Nevertheless, this method of assembly presents a few drawbacks, like the fact of requiring good accessibility of the connectors for access thereto after the mechanical assembly. This accessibility makes the cables and the connectors more accessible to any damage in the use of the robot because of undesirable movements or because of external elements that might come to damage the connection elements. It would be possible to ensure the protection of the cables after their connection. However, that would lead to additional mechanical parts which increase the complexity of the robot.

The invention aims mostly to mitigate this defect by proposing, for an articulation of the robot, the connection of cables before the mechanical assembly of the articulation. This makes it possible to protect the cables and the connectors inside the articulation.

To this end, the subject of the invention is a method for assembling a robot of humanoid type, comprising:

two elements,

an articulation with at least one degree of freedom in rotation linking the two elements about an axis, the articulation being able to be mounted and dismantled in order to join and separate the two elements,

a box with circular section fixed to a first of the two elements and extending along an axis substantially parallel to the axis of rotation of the articulation,

a cable having two ends of which a first is connected to the first element and a second is connected to the second element,

the cable being partly wound in the box about the axis of the box and extends out of the box to its second end, between a separated configuration of the two elements and a joined configuration of the two elements, an elasticity of the cable allowing it to be wound in the box, the method being characterized in that it consists in sequencing, in order, the following operations:

connecting the cable at its two ends, respectively to the first and to the second of the two elements

mechanically mounting the articulation.

The invention can make it possible to connect the cable before joining the two elements by means of the articulation. That makes it possible to carry out operation tests, for example electrical, the two elements being separated.

The invention is described in relation to the articulation of the head and of the trunk of a robot of humanoid type. It is of course possible to implement the invention for all the other articulations of the robot such as, for example, the articulation of the shoulder joining an arm to the trunk, the articulation of the elbow joining the forearm to the arm, the articulation of the hip joining the leg to the trunk, etc.

The invention more particularly addresses two connections of different type linking the two elements of the robot, one being mechanical. Many robots use electrical energy for their actuators, notably those of the articulations and for the driving thereof for example performed by means of electronic boards linked to sensors of any kind, allowing links to the outside of the robot, and driving the actuators. The electrical power and the electrical signals are required to pass through the different articulations of the robot. In the example described, the articulation of the neck connects the trunk to the head mechanically and electrically by means of a flexible cable. It is of course possible to implement the invention with other forms of energy instead of or in addition to the electrical energy. It is notably possible to convey, by the cable, power and/or hydraulic or optical signals. In other words, the cable comprises at least one electrical and/or optical and/or hydraulic conductor.

The invention will be better understood and other advantages will emerge on reading the detailed description of an embodiment given by way of example, the description being illustrated by the attached drawing in which:

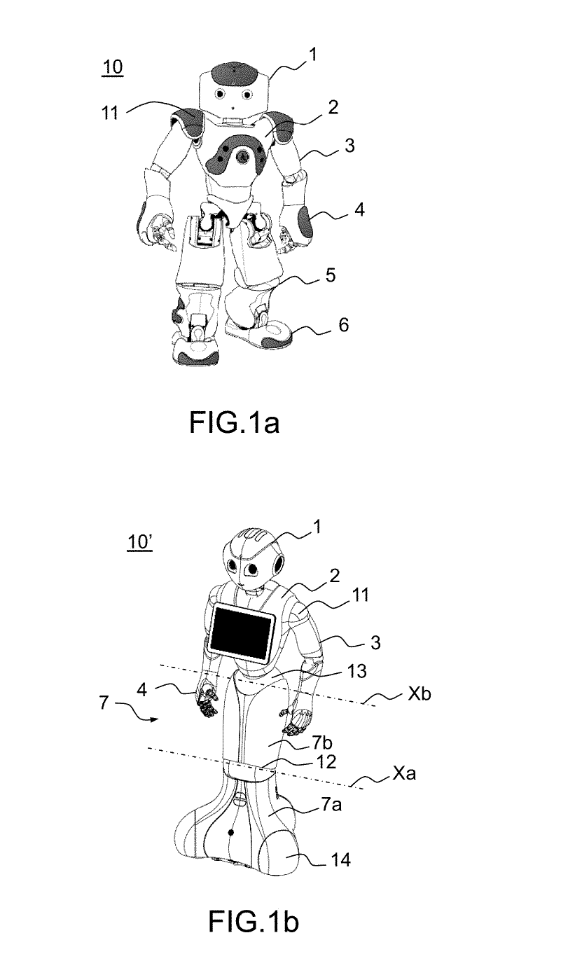

FIGS. 1a and 1b represent two examples of robots that can implement the invention;

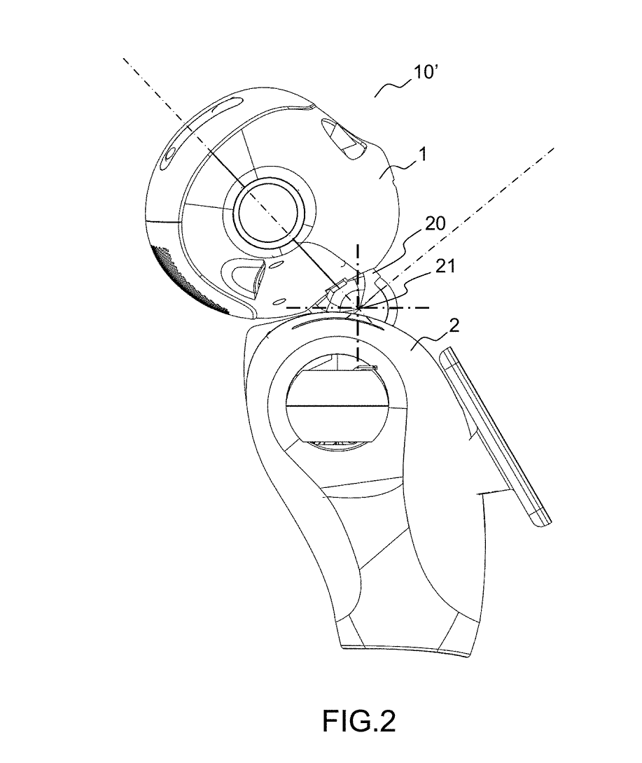

FIG. 2 represents, in cross section in a sagittal plane, the head and the trunk of the robot of FIG. 1b;

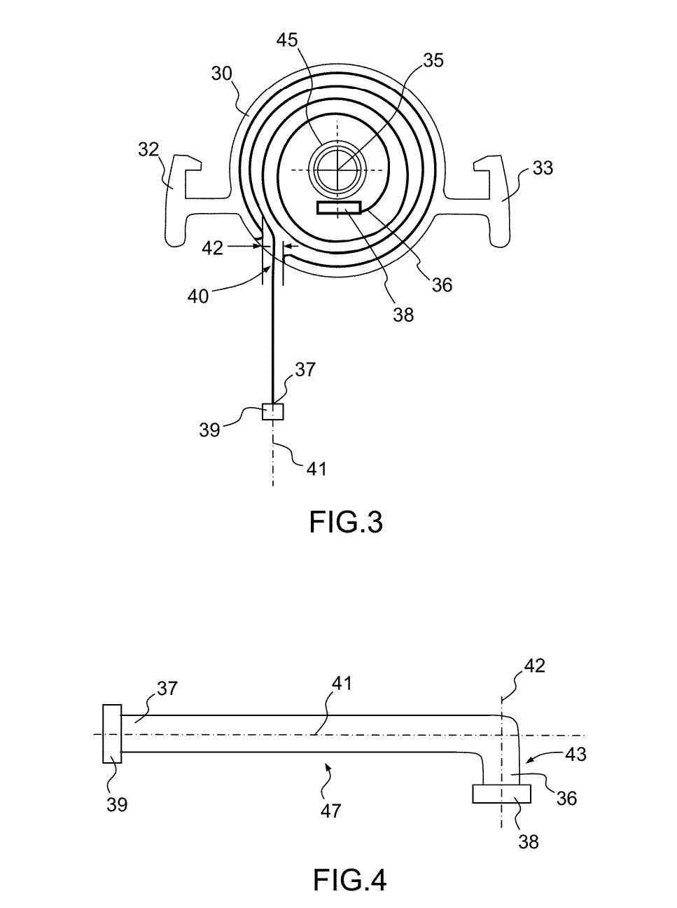

FIG. 3 represents a box in which a cable making it possible to connect the head and the trunk of the robot is partially wound;

FIG. 4 represents the cable unwound;

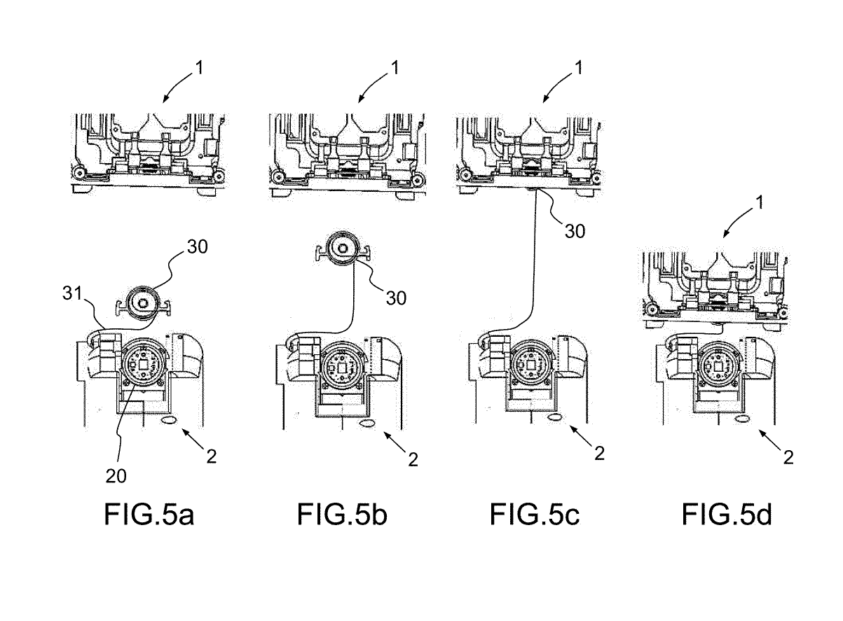

FIGS. 5a to 5d represent several steps of assembly of the head and of the trunk of the robot.

For clarity, the same elements will bear the same references in the different figures.

FIGS. 1a and 1b represent two examples of robots of humanoid type developed by the company ALDEBARAN ROBOTICS™. The humanoid robot 10 represented in FIG. 1a comprises a head 1, a trunk 2, two arms 3, two hands 4, two legs 5 and two feet 6. The humanoid robot 10′ represented in FIG. 1b comprises a head 1, a trunk 2, two arms 3, two hands 4 and a skirt 7. These two robots comprise several articulations allowing the relative movement of the different limbs of the robot in order to reproduce the human morphology and its movements. The robots 10 and 10′ comprise, for example, an articulation 11 between the trunk 2 and each of the arms 3. The articulation 11 forming a shoulder of the robot is motorized about two axes of rotation to make it possible to move the arm 3 relative to the trunk 2 in the manner of the possible movements by a shoulder of a human being.

The robot of humanoid type 10 also comprises several articulations to move the legs of the robot and reproduce the walking movement, in particular articulations that can be likened to a hip, between the trunk and each of the thighs, to a knee, between the thigh and the leg, and to an ankle between the leg and the foot. Several forms of motorized articulations are implemented, driving one limb movement according to one or more degrees of freedom in rotation.

The robot of humanoid type 10′ has a different architecture. To improve the stability and lower the center of gravity of the robot, the robot does not have any legs but a skirt 7 comprising, at its base, a tripod 14 capable of moving the robot around. The skirt 7 also comprises a first articulation 12 that can be likened to a knee, between a leg 7a and a thigh 7b. A second articulation 13 that can be likened to a hip is links the trunk 2 and the thigh 7b. These two articulations 12 and 13 are pivot links motorized about an axis of rotation. The axis of rotation Xa of the articulation 12 and the axis of rotation Xb of the articulation 13 are substantially parallel to an axis linking the two shoulders of the robot, making it possible to tilt the robot forward or backward.

FIG. 2 represents, in cross section in a sagittal plane, the head 1 and the trunk 2 of the robot 10′ of FIG. 1b. The head 1 and the trunk 2 are linked by a neck 20 forming an articulation with three degrees of freedom in rotation. Initially, the focus here is on the rotation that the neck 20 allows about an axis 21 at right angles to the sagittal plane of the robot, that is to say at right angles to the plane of FIG. 2. The neck 20 allows a rotation of the head 1 relative to the trunk 2. In FIG. 2, the head 1 is in the vicinity of one of the ends of its angular range.

The rotation of the head 1 can be obtained by means of an actuator making it possible to motorize the articulation of the neck 20 or by an external action, for example when an external force is exerted on the head 1 or in a rapid movement of the head 1 driving the latter by inertia.

FIG. 3 represents a box 30 in which a cable 31 is partially wound. The box 30 is intended to be fixed to the head 1, for example by clipping done by means of the two lugs 32 and 33. Any other dismantlable fixing means is possible for fixing the box 30 to the head 1, for example by screws. The box 30 has a circular section centered about an axis 35 at right angles to the plane of FIG. 3. Once the assembly of the articulation has been completed, the axis 35 is parallel to the axis of rotation 21 of the neck 20.

The cable 31 has two ends 36 and 37. The first end 36 is connected to the head 1 by means of a connector 38 and the second end 37 is connected to the trunk 2 by means of a connector 39. The cable 31 is partly wound in the box 30 about the axis 35 of the box 13 from its first end 36. The cable 31 extends out of the box 30 to its second end 37.

The box 30 comprises an orifice 40 passed through by the cable 31. From the orifice 40 and at least over a part of its extension out of the box 30, the cable 31 follows a rectilinear direction 41 at right angles to the axis 35. To facilitate the exit of the cable from the box 30, the orifice 40 has a section 42 substantially at right angles to the direction 41 of the cable 31 extending out of the box 30.

The cable 31 is wound in the box 30 about its first end 36. The winding is done in spiral manner about the first end 36 to the exit of the cable 31 from the box 30 through the orifice 40.

The cable 31 makes it possible to electrically link the head 1 and the trunk 2. By virtue of the invention, the mechanical mounting of the articulation can be done after its electrical connection. Two mechanical configurations of the articulation are defined, one, called separated, in which the head 1 and the trunk 2 are at a distance from one another and have between them six degrees of freedom, the other, called joined, in which the articulation 20 is operational. In other words, in the joined configuration, the articulation is mechanically connected, and the head 1 and the trunk 2 have between them the number of degrees of freedom defined by the articulation, that is to say at least one degree of freedom in rotation. Between the two configurations, the cable 31 is wound more or less into the box 30. More specifically, in the separated configuration, the cable 31 is less wound than in the joined configuration. The winding and the unwinding of the cable is obtained by means of the elasticity of the cable 31. More specifically, it is possible to pull on the end 37 of the cable 31 in the direction 41 to partially unwind the cable 31 from the box 30. In the unwinding, the different turns of the cable 31 formed in the box 30 tend to tighten toward the axis 35 of the box 30. The unwinding makes it possible to distance the connector 39 from the box 30 in order to facilitate the connection thereof in separated configuration.

When the pulling force on the cable 31 by its end 37 is relaxed, the cable 31 is wound naturally into the box 30 by virtue of its elasticity. The turns of the cable 31 tend to increase their radius of curvature. The elasticity of the cable tends to increase its radius of curvature.

FIG. 4 represents an example of a cable 31 with flat section that can be implemented in the invention. In FIG. 4, the cable 31 is represented fully unwound prior to its introduction into the box 30. Unwound, the cable 31 extends in the plane of FIG. 3. To ensure electrical connections, the cable 31 can be produced in the form of a flexible printed circuit. The conductors are for example produced in copper etched on a plastic support such as a polyimide. The cable 31 extends mainly in the direction 41. The flat section is defined at right angles to the direction 41 and extends in the plane of FIG. 4. At the end 36, the cable 31 can be bent in order to facilitate the connection of the connector 38 out of the box 30. In the example represented, the cable 31 follows a direction 42, at right angles to the direction 41 in the vicinity of the end 36 over a part 43 of the cable 31.

In other words, the cable 31 comprises at least one conductor extending at right angles to its flat section, that is to say parallel to the direction 41. The at least one conductor is bent to allow the cable 31 to exit from the box 30 at its first end 36.

The box 30 can comprise a central core 45 to which the connector 38 can be fixed. When mounting the cable 31 in the box 30, the connector 38 is held in a fixed position relative to the central core 45, if it exists, or relative to the centre of the box 30, then the cable 31 is spirally wound about its end 36, then it is led out through the orifice 40. The bent part 43 of the cable 31 in the vicinity of the end 36 facilitates the holding of the cable 31 in the box 30 during winding.

Before being put in place in the box 30, the cable 31 has a straight part 47 extending naturally, that is to say without external stress, in the direction 41. It is this part which is wound about the end 36. More generally, the cable 31 has a part 47 that can extend without stress rectilinearly. The rectilinear part 47 is wound in the box 30.

The flat section of the cable 31 extends all along the part of the cable 31 wound in the box 30. The flat section of the cable 31 extends along an axis parallel to the axis 35 of the box 30.

A flat cable is well suited to an articulation 20 with one degree of freedom in rotation. In the joined configuration, that is to say when the articulation is operational, in its part situated outside of the box 30, the cable can easily flex about an axis parallel to the axis 35 of the box 30, that is to say flex about the axis of rotation of the articulation 20. If the head 1 is required to be articulated relative to the trunk 2 with two or three degrees of freedom in rotation, it is possible to dissociate the degrees of freedom by combining them in series with an intermediate part between each of the degrees of freedom. It is possible to associate, with each degree of freedom, a box 30 and a cable 31 as described here. That makes it possible to join or separate each part of the articulation independently of one another. It is also possible to provide a single degree of freedom having its box 30 and its cable 31. For the other degree or degrees of freedom, it is possible to provide cabling without possible separation as for example described in the patent application WO 2010/057950 filed in the name of the applicant company and included here for reference.

Alternatively, the cable 31 can have a round section. As for a cable with flat section, the cable with round section has a part that can extend without stress rectilinearly in the direction 41. This rectilinear part is wound in the box 30. A cable with round section can flex, in its part situated outside of the box 30, according to two axes at right angles to the axis 41 and possibly twist about the axis 41. A cable with round section is well suited to an articulation with several degrees of freedom, the first end 36 of the cable 31 being linked to the first element, the head 1 in the example described, and the second end 37 of the cable 31 being linked to the second element, the trunk 2 in the example described.

FIGS. 5a to 5d represent a number of steps of assembly of the head 1 and of the trunk 2. Any caps forming the skin of the robot have been removed to perform the assembly. For the head 1 and the trunk 2, structures internal to the head and to the trunk are essentially distinguished. In the trunk 2, the articulation 20 is distinguished. In FIG. 5a, the cable 31 is connected to the trunk 2 and the box 30 is situated in immediate proximity to the trunk. In the position of FIG. 5b, the box 30 is pulled to distance it from the trunk 2 and bring it closer to the head 1. By pulling on the box 30, the cable 31 is partially unwound from the box 30. In the position of FIG. 5c, the box 30 is fixed to the head 1 and the connection of the cable 31 is made in the head 1. In the position of FIG. 5c, the articulation 20 is not put in place mechanically but it is possible to make the head 1 operate electrically relative to the trunk 2, the cable 31 connecting the two elements 1 and 2. This notably makes it possible to carry out electrical tests of correct operation before the complete assembly of the robot. After electrical connection and before mechanical mounting of the articulation 20, the two elements retain six degrees of freedom in their movement relative to one another. The only limitation in the movement of the two elements 1 and 2, one relative to the other, is given by the presence of the cable 31 connected. The flexibility of the cable 31 allows the relative movement of the two elements 1 and 2 relative to one another.

In the position of FIG. 5d, the head 1 is brought closer to the trunk 2 to allow the mechanical mounting of the articulation 20. In the bringing together of the head 1 relative to the body, the cable 31 is wound in the box 30 by virtue of its elasticity. More specifically, the operation of mechanically mounting the articulation consists in sequencing, in order, two steps:

bringing together of the two elements 1 and 2, in the bringing together, the cable 31 is wound in the box 30 by virtue of its elasticity

mechanical attachment of the two elements 1 and 2.

This method of assembly in two successive operations consisting first of all in making the electrical connections then in making the mechanical connection of the articulation also makes it possible to protect the electrical connections of the articulation 20. These connections are not apparent once the mechanical assembly of the articulation 20 is complete. The connections and the cable 31 allowing these connections are fully protected inside the articulation.

The dismantling of the articulation is done first of all by mechanically dismantling the articulation 20 then by electrically disconnecting the cable 31. It is not possible to disconnect the cable 31 as long as the articulation 20 remains assembled.

1. A method for assembling a robot of humanoid type, comprising:
two elements,
an articulation with at least one degree of freedom in rotation linking the two elements about an axis, the articulation being able to be mounted and dismantled in order to join and separate the two elements,
a box with circular section fixable to a first of the two elements and extending along an axis substantially parallel to the axis of rotation of the articulation,
a cable having two ends of which a first is connectable to the first element and a second is connectable to the second element,
the cable being partly wound in the box about the axis of the box and extending out of the box to its second end, an elasticity of the cable allowing it to be wound in the box, between a separated configuration of the two elements and a joined configuration of the two elements, the method comprising sequencing, in order, the following operations:
connecting the cable at its two ends, respectively to the first and to the second of the two elements in a separated configuration of the two elements,
mechanically mounting the articulation.

2. The method as claimed in claim 1, wherein the operation of mechanically mounting the articulation consists in sequencing, in order, two steps:
bringing together the two elements, in the bringing together, the cable is wound in the box because of its elasticity,
mechanical attachment of the two elements.

3. The method as claimed in claim 2, wherein the cable has a part that can extend without stress rectilinearly and wherein the rectilinear part is wound in the box in the bringing together of the two elements.

4. The method as claimed in claim 2, wherein the cable has a flat section all along the part of the cable which is wound in the box and wherein the flat section extends along an axis parallel to the axis of the box.

5. The method as claimed in claim 4, wherein the cable comprises at least one conductor extending at right angles to the flat section and wherein the at least one conductor is bent to allow the cable to exit from the box at the first end of the cable.

6. The method as claimed in claim 1, wherein the articulation has several degrees of freedom in rotation after mounting and wherein the cable has a round section.

7. The method as claimed in claim 1, wherein the cable is wound in the box about its first end.

8. The method as claimed in claim 1, wherein the box comprises an orifice passed through by the cable, the orifice having a section substantially at right angles to a direction of the cable extending out of the box.

9. The method as claimed in claim 1, wherein the cable comprises at least one electrical conductor.

10. The method as claimed in claim 1, wherein the cable comprises at least one optical conductor.

11. The method as claimed in claim 1, wherein the cable comprises at least one hydraulic conductor.

12. The method as claimed in claim 1, wherein the first element is a head of the robot and wherein the second element is a trunk of the robot.
